(19) United States
(12) Patent Application Publication
(10) Pub. No.: US 2014/0025350 A1
(43) Pub. Date: Jan. 23, 2014

(54) STATISTICAL MODELING BASED ON BIT-ACCURATE SIMULATION OF AN ELECTRONIC DEVICE

(71) Applicants: Xingdong Dai, Whitehall, PA (US); Yasser Ahmed, Allentown, PA (US)

(72) Inventors: Xingdong Dai, Whitehall, PA (US); Yasser Ahmed, Allentown, PA (US)

(73) Assignee: LSI CORPORATION, Milpitas, CA (US)

(21) Appl. No.: 13/553,983

(22) Filed: Jul. 20, 2012

(51) Int. Cl. G06F 17/50

(52) U.S. Cl. 703/2

(57) ABSTRACT

Operations of an electronic device are simulated by generating and executing a bit-accurate model of the device using an input signal having at least one transition that corresponds to a step input having a pre-transition value (e.g., 0 for a positive transition) for a specified duration before the transition and a post-transition value (e.g., 1 for a positive transition) for a specified duration after the transition. The corresponding step-response results are differentiated with respect to time to generate impulse-response results for the device. The impulse-response results are converted into the frequency domain to determine frequency-domain characteristics of the device that are used to generate a statistical model of the device, which can be executed to simulate all operations of the device, include low bit-error-rate (BER) simulations that would take too long to simulate using the bit-accurate model.

### BACKGROUND

This section introduces aspects that may help facilitate a better understanding of embodiments of the invention. Accordingly, the statements of this section are to be read in this light and are not to be understood as admissions about what is prior art or what is not prior art.

The IBIS (input/output buffer information specification) standard along with its AMI (algorithmic modeling interface) extension provide a format for modeling and simulating the operations of electronic devices, such as those implemented in integrated circuits. IBIS can be used to perform two different approaches to device modeling and simulation flow: (i) statistical simulation mode when the device has a linear and time-invariant (LTI) model and (ii) time-domain or bit-by-bit simulation mode for a non-linear and/or time-variant (NLTV) device model. NLTV modeling, also known as bit-accurate modeling, is more accurate than LTI modeling, but requires more computational resources and, as a result, typically takes longer to perform, especially for low bit-error rate (BER) simulations. LTI modeling, also known as statistical modeling, simplifies math and/or computing power required to perform serial link analysis and, as a result, can be performed more quickly, but is typically less accurate than NLTV modeling.

### BRIEF DESCRIPTION OF THE DRAWINGS

Other aspects, features, and advantages of the invention will become more fully apparent from the following detailed description, the appended claims, and the accompanying drawings in which like reference numerals identify similar or identical elements.

FIG. 1 shows a timing diagram of an exemplary simulation based on conventional NLTV (non-linear and/or time-variant) modeling of an electronic device;

FIG. 2 shows a graphical representation of the pulse response of a channel that supplies an input signal to an electronic device to be modeled;

FIG. 3 shows a graphical, time-domain representation of the waveform of the bit pattern of an exemplary output signal from an exemplary electronic device; and

FIG. 4 shows a flow diagram of a computer-implemented method for simulating operations of an electronic device, according to one embodiment of the disclosure.

### DETAILED DESCRIPTION

FIG. 1 shows a timing diagram of an exemplary simulation based on conventional NLTV (non-linear and/or time-variant) modeling of an electronic device. During an initial model setup time period 102 following the simulation start time, elements (for example, equalization adaptive loops and clock data recovery (CDR)) of the NLTV model settle and converge. Since the NLTV model has not yet settled and converged during this model setup period, the simulation results (i.e., Ignore_Bits) generated for this period are not useful and are therefore ignored. Following the model setup period, there is a subsequent, simulation period 104, during which the NLTV model generates useful time-domain results (i.e., TimeDomain_Bits).

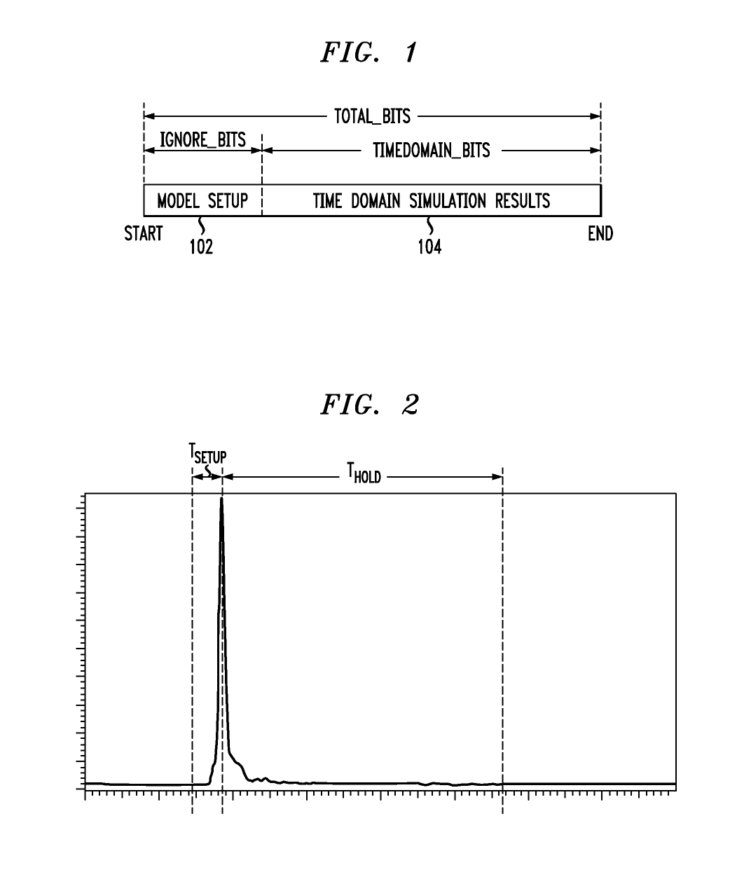

FIG. 2 shows a graphical representation of the pulse response of a channel that supplies an input signal to an electronic device to be modeled. A channel can be electrical backplanes or optical cables or connectors. In general, digital information can be transmitted over virtually any channel. Transmission applications or media include, but are not limited to, coaxial cable, twisted pair conductors, optical fiber, radio frequency channels, wired or wireless local area networks, digital subscriber line technologies, wireless cellular, Ethernet over any medium such as copper or optical fiber, cable channels such as cable television, and Earth-satellite communications.

As indicated in FIG. 2, there are a time period, having a duration of T_{hold}, that follows the peak of the pulse response from the channel, and a time period, having a duration of Tₛₑₜᵤₚ, that precedes the peak of the pulse response from the channel, during which the output signal is unsettled and is not at a steady state level. As such, the time period defined by durations Tₛₑₜᵤₚ and T_{hold} represents a minimum window for emulating LTI model behaviors of the device using the NLTV model and simulation methods.

According to one embodiment of the disclosure, an LTI (linear and time-invariant) model for an electronic device is generated by first simulating the step response of the device using an NLTV model. The results are then differentiated with respect to time to determine the impulse response of the device.

The impulse response is then transformed (e.g., using Fourier transform (FT)) into the frequency domain. Frequency-domain characteristics of the impulse response are then determined and used to generate the LTI model for the device. In this way, the NLTV model for a device is used to generate the LTI model for the device.

Values for the setup and hold durations Tₛₑₜᵤₚ and T_{hold} can be determined from impulse-response or pulse-response analysis performed automatically in electronic design automation (EDA) tools before running any NLTV or LTI channel simulations. In particular, the setup duration Tₛₑₜᵤₚ can be determined from the time difference between the maximum impulse/pulse value and the last, preceding continuous steady-state value, while the hold duration T_{hold} can be determined from the time difference between the maximum impulse/pulse value and the first, subsequent continuous steady state value.

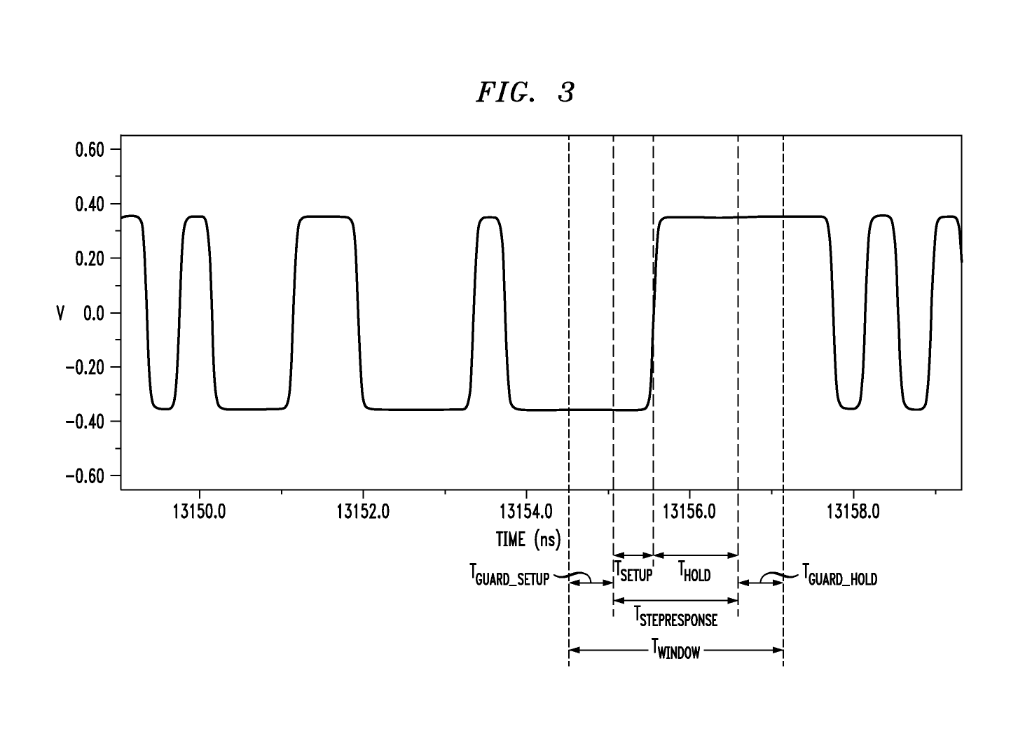

FIG. 3 shows a graphical, time-domain representation of the waveform of the bit pattern of an exemplary output signal from an exemplary electronic device. As shown in FIG. 3, at about time=13155.5 ns, the input signal transitions from a low value of about −0.35V to a high value of about +0.35V. Prior to that transition, the input signal is low for more than the Tₛₑₜᵤₚ duration of FIG. 2. In fact, the signal is low for more than (Tₛₑₜᵤₚ+T_{guard}_{_{—}}ₛₑₜᵤₚ), where T_{guard}_{_{—}}ₛₑₜᵤₚ is a setup guardband period. Similarly, following the transition at about time=13155.5 ns, the input signal is high for more than the T_{hold} duration of FIG. 2. In fact, the signal is high for more than (T_{hold}T_{guard}_{_{—}}_{bold}), where T_{guard}_{_{—}}_{hold} is a hold guardband period. Note that Tₛₑₜᵤₚ+T_{hold} defines a step-response duration T_{StepResponse}, while T_{guard}_{_{—}}ₛₑₜᵤₚ+Tₛₑₜᵤₚ+T_{hold}+T_{guard}_{_{—}}_{hold} defines a window function T_{window}. Depending on the particular implementation, the guardband periods T_{guard}_{_{—}}ₛₑₜᵤₚ and T_{guard}_{_{—}}_{hold} are defined as specified durations or as specified percentages of the step-response duration T_{StepResponse}.

Note that the duration of the window function T_{window} is specifically selected to be long enough so that sufficient information will be captured for statistical analysis, while being short enough so that adaptive loops are considered static or quasi-static given the underlying model implementations.

The transition from low to high that occurs at about time=13155.5 ns can be used to simulate the step response of the device because (i) the duration of the input signal being low prior to the transition is greater than (Tₛₑₜᵤₚ+T_{guard}_{_{—}}ₛₑₜᵤₚ) and (ii) the duration of the input signal being high following the transition is greater than (T_{hold}+T_{guard}_{_{—}}_{hold}). No other low-to-high transition in FIG. 3 satisfies those conditions.

Note that a “positive” step occurs when the input signal transitions from low to high, while a “negative” step occurs when the input signal transitions from high to low. A transition from high to low can be used to simulate a negative step response of the device if (i) the duration of the input signal being high prior to the transition is greater than (Tₛₑₜᵤₚ+T_{guard}_{_{—}}ₛₑₜᵤₚ) and (ii) the duration of the input signal being low following the transition is greater than (T_{hold}+T_{guard}_{_{—}}_{hold}). For the input signal depicted in FIG. 3, none of the high-to-low transitions is ideal (in terms of T_{window}) for simulating the negative step response of the device, although the transition at about time=13152.0 ns is marginally suitable (in terms of T_{StepResponse}) since (i) the preceding high duration is at least greater than Tₛₑₜᵤₚ and (ii) the subsequent low duration is at least greater than T_{hold}. Non-ideal transitions may qualify for quasi-static modeling to be discussed in subsequent sections, if no ideal transition exists in NLTV model simulations.

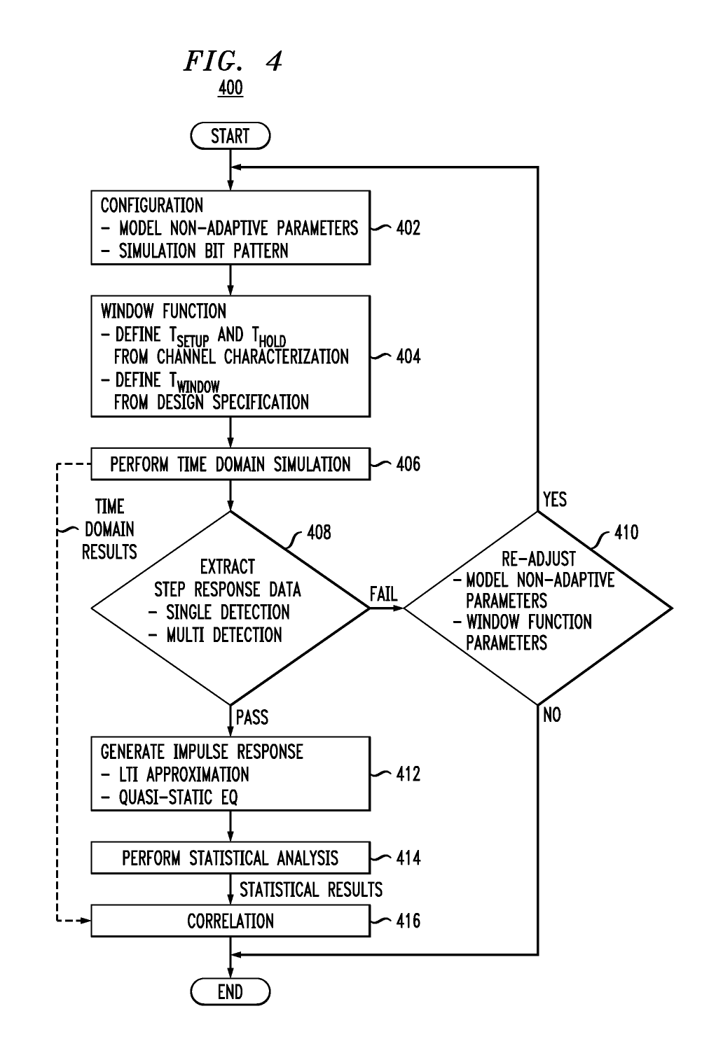

FIG. 4 shows a flow diagram of a computer-implemented method 400 for simulating operations of a device, according to one embodiment of the disclosure. In step 402, an NLTV model is generated, e.g., using a conventional IBIS-based method to set non-adaptive model parameters for the NLTV model, and the simulation input signal bit pattern is selected. If allowed, step-response stimuli can be injected into the bit stream. In step 404, the window function T_{window} is defined, where values for Tₛₑₜᵤₚ and T_{hold} are determined using a conventional channel characterization technique where the impulse or pulse responses of the passive analog channels are obtained. To obtain the impulse response, an ideal step input (e.g., a low-to-high transition with rise time equal to 0) is applied to the channel, and the channel output is recorded as a step response. The impulse response is obtained by taking derivatives on the channel output (step response). To obtain the pulse response, an ideal pulse input is applied to the channel. An ideal pulse input has rise and fall times of 0 and the pulse width is determined by the application bit rate. For example, a 10-Gbps NRZ pulse has pulse width of 100 ps. Values for T_{guard}_{_{—}}ₛₑₜᵤₚ and T_{guard}_{_{—}}_{hold} are specified in a relevant design specification. Please note that guard band time periods may be 0, in which case, T_{window} is the same as T_{StepResponse}.

In step 406, the bit-accurate NLTV model is executed to perform a time-domain simulation of the device. In step 408, the window function is applied to determine whether any of the (low-to-high or high-to-low) transitions in the input waveform are suitable (in terms of T_{window}) for generating time-domain, step-response simulation results corresponding to step inputs and, if so, the step-response data corresponding to those transitions is recorded. In one possible (e.g., multi-detection) implementation of method 400, the step-response simulation results for all suitable transitions are accumulated (e.g., averaged) in step 408. In other implementations, the step-response simulation results for only a subset of the suitable transitions are accumulated in step 408, where the subset might be only the first or only the last suitable transition in a so-called single-detection simulation.

Note that the results from both positive and negative step inputs can be accumulated in step 408. In one possible implementation, for example, where the modeled device has different rise and fall times, positive step-response results can be averaged together to characterize a typical positive step response, while .negative step-response results are separately averaged together to characterize a typical negative step response. In another possible implementation, for example, where the modeled device has balanced rise and fall times, the negative step-response results can be inverted (along the zero-crossing line) and averaged with the positive step-response results to characterize a single, typical step response that applies to both types of step inputs.

If step 408 determines that the input signal for the simulation does not have enough or even any suitable transitions (in terms of T_{window}), then, in step 410, some appropriate adjustment is made to the simulation. One possible adjustment is to select an input signal having a different bit pattern in the hope that some of its transitions would be suitable for simulating the step response of the device. Another possible adjustment is to modify one or more of the non-adaptive parameters that define the NLTV model. For example, transmit and/or receive non-adaptive equalizers can be adjusted to offset channel inter-symbol-interference (ISI) so that the output signal of the NLTV model settles faster (having sharper transition edges). Another possible adjustment is to modify the window that defines what a suitable transition is. This can be achieved by, for example, (1) reducing the guard band duration and/or (2) reducing the T_{StepResponse} time duration. When using T_{StepResponse} instead of T_{window} to determine which transitions are suitable, the guard band time duration is reduced to 0. T_{StepResponse} reduced by reducing Tₛₑₜᵤₚ and/or T_{hold}. The results of a modified window simulation might not be as accurate as those for an original T_{window}-based simulation; however, statistical simulation results are frequently still significantly better than pure LTI models.

After appropriately adjusting the simulation and/or the model in step 410, processing returns, e.g., to step 402, to perform another simulation run. If, for some reason, no appropriate adjustments can be made in step 410, then processing terminates.

If step 408 determines that the input signal for the simulation does have enough suitable transitions, then, in step 412, the impulse response of the device is generated by differentiating the accumulated simulation step-response results from step 408 with respect to time using, for example, the following formula:

Imp(n)=[V(n+1)−V(n)]/[T(n+1)−T(n)], (1)

where:
T(n) is the nth discrete time;
V(n) is the discrete simulation step-response result at time T(n); and
Imp(n) is the discrete impulse-response result at time T(n).
   In addition, in step 412, the impulse response results are converted into the frequency domain, e.g., by application of an appropriate Fast Fourier transform (FFT). Frequency characteristics of the frequency-domain results are then determined and used to generate the LTI model for the device. Many established mathematical methods can be applied. For example, MATLAB has algorithms for converting complex frequency responses to continuous time and/or discrete time transfer functions. These transfer functions are then be modeled as filters for the LTI model.

In step 414, statistical analysis of the device is then performed by executing the LTI model of the device to generate statistical results for the device.

In step 416, some of the statistical results generated in step 414 using the LTI model may be compared with corresponding time-domain results generated in step 406 using the NLTV model. Since simulations using the NLTV model can be performed in a reasonable amount of time for high-BER situations (e.g., 10⁻⁵ or higher), the statistical results generated using the LTI model for high-BER situations can be compared to the time-domain results generated using the NLTV model for those same high-BER simulations. If the statistical results conform satisfactorily with the time-domain results, then it can be reasonably assumed that other statistical results generated using the LTI model will also be satisfactory. Step 416 can be used to gain confidence in the accuracy of the LTI model for all different BER rates, including low-BER situations (e.g., 10⁻¹² or lower).

The method of FIG. 4 can provide certain advantages. For example, the method can enable statistical signal analysis on bit-accurate models and permit these models to take advantage of existing statistical signal analysis tool sets. The method can eliminate the need to develop and maintain both a statistical model and a bit-accurate model, thereby saving engineering costs and shortening development cycles. The method can also be non-invasive, because statistical model behaviors are derived from time-domain simulation results within an established electronic design automation (EDA) framework. Results from statistical signal analysis can be better matched to circuit behaviors because model parameters are a snapshot of adapted values. In comparison, pure statistical models use math formula-based analytic approaches, where adaptations, interactions, and inter-dependencies between various (e.g., equalization) loops are not difficult to be accounted for.

Although the method of FIG. 4 has been described in the context of the IBIS standard, those skilled in the art will understand that analogous methods can be implemented in other suitable contexts.

The invention may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, general-purpose computer, or other processor.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Embodiments of the invention can be manifest in the form of methods and apparatuses for practicing those methods. Embodiments of the invention can also be manifest in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. Embodiments of the invention can also be manifest in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Any suitable processor-usable/readable or computer-usable/readable storage medium may be utilized. The storage medium may be (without limitation) an electronic, magnetic, optical, electromagnetic, infrared, or semiconductor system, apparatus, or device. A more-specific, non-exhaustive list of possible storage media include a magnetic tape, a portable computer diskette, a hard disk, a random access memory (RAM), a read-only memory (ROM), an erasable programmable read-only memory (EPROM) or Flash memory, a portable compact disc read-only memory (CD-ROM), an optical storage device, and a magnetic storage device. Note that the storage medium could even be paper or another suitable medium upon which the program is printed, since the program can be electronically captured via, for instance, optical scanning of the printing, then compiled, interpreted, or otherwise processed in a suitable manner including but not limited to optical character recognition, if necessary, and then stored in a processor or computer memory. In the context of this disclosure, a suitable storage medium may be any medium that can contain or store a program for use by or in connection with an instruction execution system, apparatus, or device.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A computer-implemented method for simulating operations of an electronic device, the method comprising:
(a) generating a computer-implemented bit-accurate model of the device;
(b) executing the computer-implemented bit-accurate model to generate step-response data for the device;
(c) differentiating the generated step-response data to generate impulse-response data for the device;
(d) generating frequency-domain characteristics for the device from the generated impulse-response data;
(e) generating a computer-implemented statistical model of the device based on the generated frequency-domain characteristics; and
(f) executing the computer-implemented statistical model to simulate the operations of the device.

2. The invention of claim 1, wherein:
step (b) comprises executing the computer-implemented bit-accurate model to generate time-domain simulation results characterizing high bit-error-rate (BER) operations of the device;
step (f) comprises executing the computer-implemented statistical model to generate statistical simulation results characterizing the high BER operations of the device; and
further comprising step (g) of comparing the statistical simulation results to the time-domain simulation results to determine whether the computer-implemented statistical model is sufficiently accurate to simulate low BER operations of the device.

3. The invention of claim 1, wherein step (b) comprises:
(b1) analyzing input data for the computer-implemented bit-accurate model to determine whether the input data comprises at least one suitable data transition; and
(b2) generating the step-response data for the device based on time-domain simulation results from the computer-implemented bit-accurate model for one or more suitable data transitions.

4. The invention of claim 3, wherein each suitable data transition comprises:
an initial period longer than a specified setup duration in which the input data is substantially at a first data value; and
a final period longer than a specified hold duration in which the input data is substantially at a second data value different from the first data value.

5. The invention of claim 4, wherein step (b1) comprises:
(b1i) determining the specified setup duration based on initial settling of the computer-implemented bit-accurate model; and
(b1ii) determining the specified hold duration based on a response of the computer-implemented bit-accurate model.

6. The invention of claim 5, wherein the response is determined by applying an step or pulse input to the computer-implemented bit-accurate model.

7. The invention of claim 3, wherein the step-response data for the device is generated by averaging the time-domain simulation results for multiple suitable data transitions.

8. The invention of claim 7, wherein:
the time-domain simulation results are averaged for two or more suitable positive data transitions to generate positive step-response data for the device; and
the time-domain simulation results are averaged for two or more suitable negative data transitions to generate negative step-response data for the device.

9. The invention of claim 7, wherein the time-domain simulation results for one or more negative data transitions are inverted and averaged with the time-domain simulation results for one or more positive data transitions to generate the step-response data for the device.

10. The invention of claim 1, step (d) comprises applying a Fourier transform to the generated impulse-response data to generate the frequency-domain characteristics for the device.

11. The invention of claim 1, wherein the computer-implemented statistical model is configured to characterize low-BER operations of the device with sufficient accuracy that cannot be simulated using the computer-implemented bit-accurate model within an acceptable duration.

12. A non-transitory machine-readable storage medium, having encoded thereon program code, wherein, when the program code is executed by a machine, the machine implements a method for simulating operations of an electronic device, comprising the steps of:
(a) generating a computer-implemented bit-accurate model of the device;
(b) executing the computer-implemented bit-accurate model to generate step-response data for the device;
(c) differentiating the generated step-response data to generate impulse-response data for the device;
(d) generating frequency-domain characteristics for the device from the generated impulse-response data;
(e) generating a computer-implemented statistical model of the device based on the generated frequency-domain characteristics; and
(f) executing the computer-implemented statistical model to simulate the operations of the device.

13. A machine for simulating operations of an electronic device, the machine configured to:
(a) execute a bit-accurate model of the device to generate step-response data for the device;
(b) differentiate the generated step-response data to generate impulse-response data for the device;
(c) generate frequency-domain characteristics for the device from the generated impulse-response data;
(d) generate a statistical model of the device based on the generated frequency-domain characteristics; and
(e) execute the statistical model to simulate the operations of the device.

14. The invention of claim 13, wherein:
the machine is configured to execute the bit-accurate model to generate time-domain simulation results characterizing high bit-error-rate (BER) operations of the device;
the machine is configured to execute the statistical model to generate statistical simulation results characterizing the high BER operations of the device; and
the machine is further configured to compare the statistical simulation results to the time-domain simulation results to determine whether the statistical model is sufficiently accurate to simulate low BER operations of the device.

15. The invention of claim 13, wherein:
the machine is configured to analyze input data for the bit-accurate model to determine whether the input data comprises at least one suitable data transition; and
the machine is configured to generate the step-response data for the device based on time-domain simulation results from the bit-accurate model for one or more suitable data transitions.

16. The invention of claim 15, wherein each suitable data transition comprises:
an initial period longer than a specified setup duration in which the input data is substantially at a first data value; and
a final period longer than a specified hold duration in which the input data is substantially at a second data value different from the first data value.

17. The invention of claim 16, wherein:
the machine is configured to determine the specified setup duration based on initial settling of the bit-accurate model; and
the machine is configured to determine the specified hold duration based on a response of the bit-accurate model.

18. The invention of claim 15, wherein the machine is configured to generate the step-response data for the device by averaging the time-domain simulation results for multiple suitable data transitions.

19. The invention of claim 13, the machine is configured to apply a Fourier transform to the generated impulse-response data to generate the frequency-domain characteristics for the device.

20. The invention of claim 13, wherein the statistical model is configured to characterize low-BER operations of the device with sufficient accuracy that cannot be simulated using the bit-accurate model within an acceptable duration.
